(19) United States
(12) Patent Application Publication
(10) Pub. No.: US 2022/0072566 A1
(43) Pub. Date: Mar. 10, 2022

(54) Connection construction

(71) Applicant: Eppendorf AG, Hamburg (DE)

(72) Inventor: Steffen Kühnert, Leipzig (DE)

(73) Assignee: Eppendorf AG, Hamburg (DE)

(21) Appl. No.: 17/414,364

(22) PCT Filed: Dec. 16, 2019
(86) PCT No.: PCT/EP2019/085429

§ 371 Date: Jun. 16, 2021

(30) Foreign Application Priority Data
Dec. 18, 2018 (EP) 18213731.5

(51) Int. Cl. B04B 9/08

(52) U.S. Cl. CPC B04B 9/08; B04B 2009/085

(57) ABSTRACT

A connection construction (10), between a centrifuge rotor (12) and a drive shaft (14) of a laboratory centrifuge (100), allows one-handed operation that does not require any additional tools. The connection construction (10) is designed such that the locking mechanism (16, 48) is constantly guaranteed, preventing the jamming or blocking of the locking elements (16, 48). In addition, the user receives a reliable indication of a locked state (16, 48) by a clearly noticeable click.

### CROSS-REFERENCE TO RELATED APPLICATION

This application is a national stage application, filed under 35 U.S.C. § 371, of International Patent Application No. PCT/EP2019/085429, filed on Dec. 16, 2019, which claims the benefit of European Patent Application No. 18213731.5, filed Dec. 18, 2018.

### TECHNICAL FIELD

The present disclosure relates to a connection construction between a centrifuge rotor and a drive shaft of a centrifuge motor.

### BACKGROUND

Centrifuge rotors are used in centrifuges, in particular laboratory centrifuges, to separate the components of samples centrifuged therein by utilizing mass inertia. Increasingly higher rotation speeds are used to achieve high segregation rates. Laboratory centrifuges are centrifuges whose centrifuge rotors operate at preferentially at least 3,000, preferably at least 10,000, in particular at least 15,000 revolutions per minute, and are usually placed on tables. In order to be able to place them on a worktable, they have a form factor of less than 1 m×1 m×1 m in particular, so their installation space is limited. Preferentially, the unit depth is limited to max. 70 cm. However, laboratory centrifuges that are formed as standing centrifuges are also known; that is, they have a height in the range of 1 m to 1.5 m, so that they can be placed on the floor of a room.

Such centrifuges are used in the fields of medicine, pharmacy, biology and chemistry.

The samples to be centrifuged are stored in sample containers and such sample containers are rotationally driven by means of the centrifuge rotor. In this process, the centrifuge rotors are typically set in rotation by means of a vertical drive shaft driven by an electric motor. The coupling between the centrifuge rotor and the drive shaft is typically made by means of the hub of the centrifuge rotor.

There are different centrifuge rotors that are used depending on the application. The sample containers can contain the samples directly or separate sample receptacles that contain the sample are inserted in the sample containers, such that a large number of samples can be centrifuged simultaneously in one sample container. In general, centrifuge rotors are known in the form of fixed-angle rotors and swing-out rotors and others.

The connection construction between such centrifuge rotors and the drive shafts of the centrifuge motors, which ensures the locking of the respective centrifuge rotor on the drive shaft during the operation of the centrifuge, is mostly universal regardless of the type of centrifuge rotor, such that different types of centrifuge rotors can be used in the same centrifuge without any problems.

Such connection constructions are typically formed in such a way that there is a screw connection between the centrifuge rotor and the shaft, whereby a highly secure and durable connection can be established. A key is required to lock and release the connection; with this, the screw connection can be operated. The disadvantage of this connection construction is that, with the key, additional elements that can be mislaid are required; in addition, one-handed operation is not possible.

However, using an automatic lock that allows one-hand operation is also known at this time. This system is marketed, for example, by the company Sigma Laborzentrifugen GmbH, An der Unteren Söse 50, 37520 Osterode am Harz, under the name “G-Lock®.” A disadvantage of this, however, is that a complex redirection of centrifugal forces acting on eccentric elements to coupling elements takes place, which can be subject to numerous error pronenesses in both locking and unlocking, which can ultimately make the operation of such coupling device unsafe in everyday use. In addition, there is no feedback to the user about the locking that has taken place, such that the actual operational safety is unknown to the user.

### SUMMARY

It is therefore the object of the present disclosure to at least partially overcome such disadvantages. Preferably, one-handed operation, for which no additional tool is required, is to be made possible. In particular, the connection construction is to be constructed in such a manner that locking is always ensured, whereby the jamming or blocking of locking elements cannot occur.

This object is achieved with the connection construction as claimed. Advantageous further developments are indicated in the subclaims and in the following description together with the figures.

On the part of the inventor, it was recognized that this object can be achieved in a surprisingly simple manner if there is an actuating means on one of the elements, the drive shaft and the centrifuge rotor, which makes the locking mechanism releasable, because this enables true one-handed operation and the actuating means also effectively prevents the jamming or the like of the locking elements.

The connection construction between a centrifuge rotor and a drive shaft of a centrifuge motor extending along a shaft axis, wherein a first locking element is arranged on one of the elements of centrifuge rotor and drive shaft and a second locking element is arranged on the other of the elements of centrifuge rotor and drive shaft, wherein the first locking element is engaged with the second locking element in the locked state of the connection and is disengaged in the unlocked state, is characterized in that there is an actuating means on one of the elements of centrifuge rotor and drive shaft, the actuation of which causes the first locking element to disengage from the second locking element, by which the centrifuge rotor is removable from the drive shaft.

In an advantageous further development, it is provided that the first locking element is a lever. This makes locking particularly easy to manage. If the lever arm of the lever can be moved in a plane parallel to the shaft axis, the connection construction can be formed to be particularly slim. This is even more so if the lever arm is movable in a plane that includes the shaft axis. In this context, “lever arm” means the part of the lever that enters into the locked state with the second locking element.

In an advantageous further development, it is provided that the lever, in an undeflected basic state, is arranged at an acute angle with respect to the shaft axis, preferentially having an angle in the range of 1° to 20°, preferably an angle in the range of 2° to 15°, in particular an angle in the range of 3° to 10°, because the locking mechanism is then formed to be particularly secure and easy to actuate.

In an advantageous further development, it is provided that the connection construction is adapted such that the lever is deflectable in a first operating state with the centrifuge rotor rotating (centrifuge rotor and centrifuge motor are connected, the centrifuge rotor rotates) due to centrifugal forces relative to a second operating state with the centrifuge rotor not rotating (centrifuge rotor and centrifuge motor are connected, the centrifuge rotor, however, does not rotate), wherein the deflection relative to the second operating state is preferentially in the range of 1° to 5°, preferably in the range of 1° to 3°, in particular in the range of 1° to 2°. The deflection being in this range means that at least one deflection corresponding to the lower limit will occur due to centrifugal forces, but in doing so the deflection is limited to the upper limit; that is, it will not exceed such upper limit. The lever and second locking element are thus formed to enable deflection due to centrifugal forces, but at the same time to limit it. This is possible, for example, by the fit of the lever on the second locking element having a radial stop for the lever that, however, has a distance in the radial direction with respect to the second operating state that enables the limited deflection. This results in self-locking of the lever.

In an advantageous further development, it is provided that the lever is arranged on a joint. This makes the lever function even easier to implement in terms of design. Preferably, the joint is formed to be spring-loaded, because this provides restoring forces. The joint can also be effected by an elastic, spring-loaded design of the lever itself.

In an advantageous further embodiment, it is provided that the first locking element has a foot that stands on the second locking element. As a result, the locking is highly secure and can be repeated over the long term.

In an advantageous further development, it is provided that the first connecting means has at least one chamfer, which serves as a locking aid, wherein the chamfer preferably lies parallel to the longitudinal extension of the lever. This makes the connection construction particularly easy to lock, because it means that the first locking means does not present an obstacle when the centrifuge rotor is fitted onto the drive shaft.

In an advantageous further embodiment, it is provided that the first locking element is preloaded in the direction of engagement with the second locking element. This allows the locking to take place automatically without regard to the operating status of the centrifuge. At the same time, the preloading can also serve as a preloading for the actuating means, wherein, however, a separate preloading is preferably provided for the actuating means.

In an advantageous further development, it is provided that the first locking element is arranged on the drive shaft. This allows the connection construction to be kept very compact. Advantageously, it is then provided that there are at least four first locking elements, preferably six first locking elements. This makes the lock particularly secure.

In an advantageous further development, it is provided that the second locking element is a projection on the centrifuge rotor, against which the first locking element is supported in the locked state. Thereby, the connection construction is structured to be particularly simple.

In an advantageous further development, it is provided that the actuating means has a contact surface for a mating contact surface of the first locking element, wherein one of the two surfaces of contact surface and mating contact surface has an inclined course in the actuating direction of the actuating means, at least in the locked state of the connection construction, in such a manner that actuation of the actuating means causes the first locking element to pivot. This makes unlocking particularly easy to achieve.

In an advantageous further development, it is provided that the mating contact surface runs in a manner inclined to the direction of the shaft axis in the locked state. This makes it very easy to unlock levers arranged on a joint, for example. The contact surface will then preferably be straight in the direction of the shaft axis, but can also have a slope, which must, however, be dimensioned so that an unlocking force is exerted on the first locking element when the actuating means is displaced in the actuating direction.

In an advantageous further development, it is provided that the first locking element and the second locking element have contact surfaces that, in the locked state of the connection construction, bear against one another and effect the locking, wherein such contact surfaces are inclined with respect to a radial surface about the shaft axis. This allows the locked state to engage early when the centrifuge rotor is pushed onto the drive shaft, such that vertical play is minimized between the centrifuge rotor and drive shaft.

In an advantageous further development, it is provided that the actuating means is formed as a push button that is preloaded against the actuating direction. This makes unlocking particularly easy and ergonomic.

In an advantageous further development, it is provided that the actuating means exists on the centrifuge rotor. Thereby, the drive shaft can be designed to be compact. Alternatively, however, the actuating means could also exist on the drive shaft.

In an advantageous further development, it is provided that the connection construction provides a snap-in connection, wherein the locking takes place within the framework of a clip connection, which is designed to be releasable. This makes the locking mechanism particularly secure, and the user can hear the locking mechanism click into place, making it very easy to verify the safety provided.

The features and further advantages of the present invention will become apparent below from the description of a preferred exemplary embodiment in connection with the figures.

### BRIEF DESCRIPTION OF THE DRAWINGS

FIG. 1 shows the connection construction in a first preferred embodiment in the unlocked and separated state in section.

FIG. 2 shows the connection construction according to FIG. 1 in the locked state in section.

FIG. 3 shows the connection construction according to FIG. 1 in the unlocked state in section.

FIG. 4 shows the hub of the centrifuge rotor of the connection construction according to FIG. 1 in a perspective view in section.

FIG. 5 shows the drive shaft of the centrifuge rotor of the connection construction according to FIG. 1 in a perspective view.

FIG. 6 shows the connection construction according to FIG. 1 in a detail view in section.

FIG. 7 shows a laboratory centrifuge with the connection construction according to FIG. 1.

### DETAILED DESCRIPTION

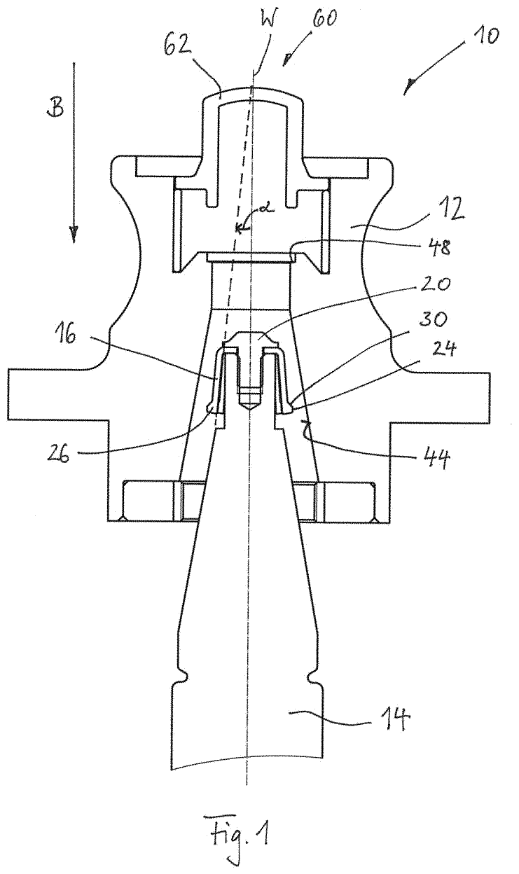

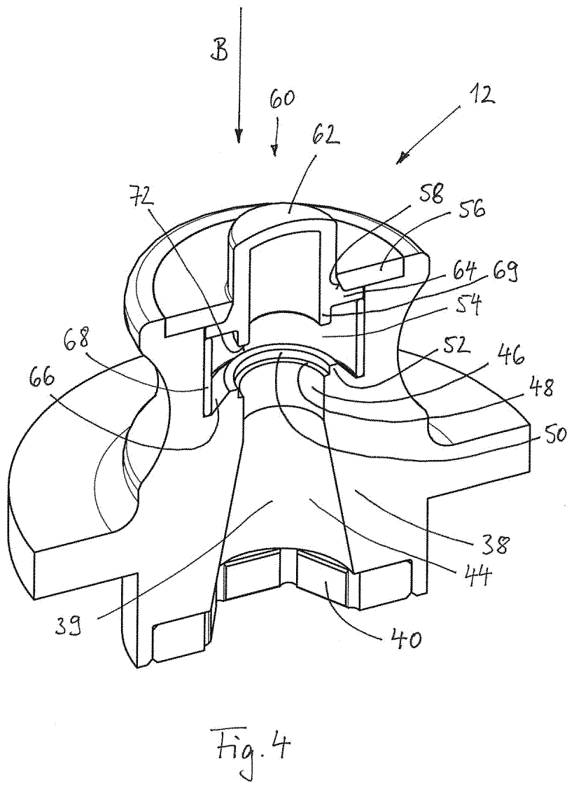

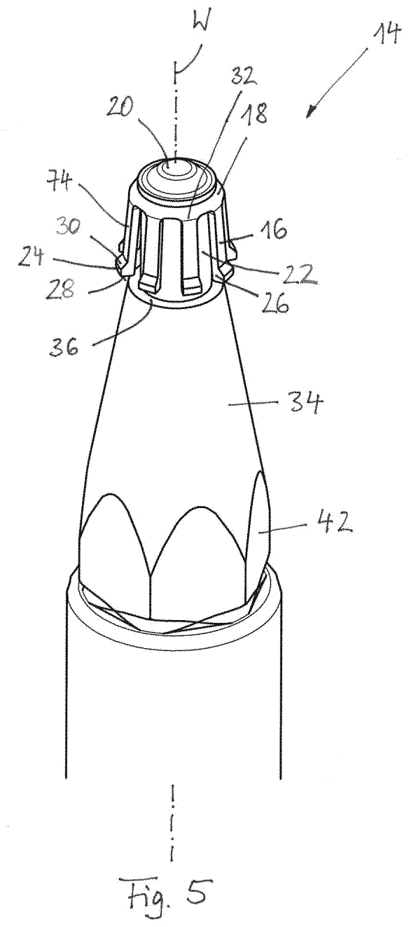

In FIGS. 1 to 6, the connection construction 10 is shown in various views in a preferred embodiment.

It can be seen that the connection construction 10 between a centrifuge rotor 12, which is only partially shown, and a drive shaft 14, which is only partially shown, of a centrifuge motor, which is not shown further, has eight spring elements 16 as first locking elements, which are arranged on a common spring crown 18.

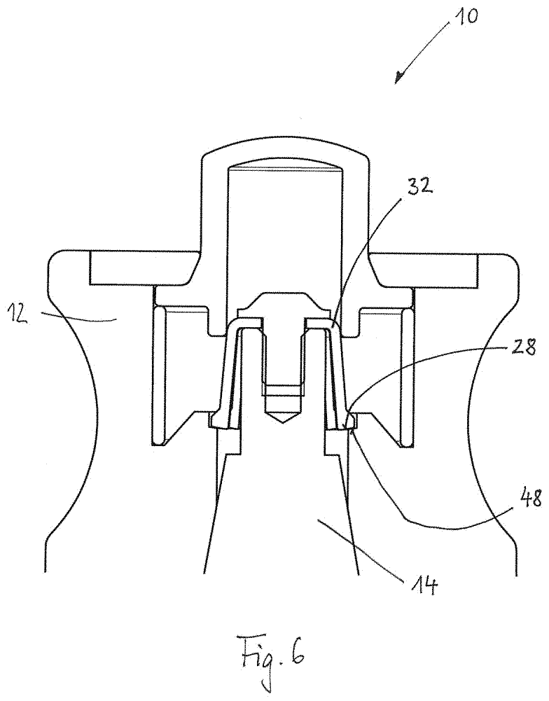

This spring crown 18 is concentrically bolted to the drive shaft 14 by a bolt 20, such that the spring elements 16 extend equidistantly from a cylindrical section 22 of the drive shaft 14. Thereby, the spring elements 16 have projections 24 that form feet 26, the base 28 of which, in the relaxed state of the spring elements 16 shown in FIG. 6, is inclined relative to a radial plane with respect to shaft axis W. Further, the projections 24 have chamfers 30, which are inclined to the longitudinal extension of the respective spring element 16.

The spring elements 16 are connected to the spring crown 18 by joints 32, which allow an elastically reversible displacement of the feet 26 toward the shaft axis W. To provide elasticity, the spring elements 16 are integral with the spring crown 18 and made, for example, of a thermoplastic or a spring steel.

The spring elements 16 thus form lever arms acting as first locking elements, which are formed to pivot relative to the spring crown 18 via the respective joints 32.

A radially extending step 36 is located at the transition between the cylindrical section 22 and the conical section 34 of the drive shaft 14, the radial depth of which corresponds at least to the radial width of the feet 26, such that the feet 26 can be displaced completely onto or behind the course of the conical profile of the conical section 34.

The hub 38 of the centrifuge rotor 12 has a receiving space 39 for the drive shaft 14 with an incorporated internal hexagon 40, which corresponds to a corresponding external hexagon 42 of the drive shaft 14 and serves to transmit torque. Preferentially, such internal hexagon 40 is made of a harder material than the hub 38 and is fixed in this hub 38, for example screwed in or shrunk in.

The transmission of the torque from drive shaft 14 to centrifuge rotor 12 thus takes place via a positive-locking connection 40, 42. As an alternative to the hexagonal design shown, there could also be another polygonal design, for example an octagonal design, or the positive-locking connection could be made by a tongue-and-groove connection or also a drive pin-and-groove connection or other positive-locking connections that permit torque transmission.

The hub 38 further includes an inner cone 44, which corresponds to the conical section 34 of the drive shaft 14 and serves to provide a perfectly aligned fit of the centrifuge rotor 12 on the drive shaft 14 and a frictional fit. Such inner cone 44 merges into an inner cylinder 46, the diameter of which is at least equal to the outer diameter of the step 36, but preferably larger, wherein it is smaller than the outer diameter of the feet 26 in the relaxed state of the spring elements 16.

Further, above the inner cylinder 46, there is an annular step 48, which is bounded radially outwardly by a vertical edge 50, which belongs to a circumferential elevation 52 surrounding the step 48. This step 48 forms the second locking element. The edge 50 surrounds an inner diameter that is only slightly larger than the outer diameter of the feet 26 in the relaxed state. This ensures a secure locking while still allowing the projections 24 to strike the edge 50 during the sudden relaxation of the spring elements 16.

Furthermore, the hub 38 has a cylindrical cavity 54 above the elevation 52, which is bounded at the top by a lid-shaped closure element 56. In such closure element 56, which can be screwed into the hub 38, for example, there is an aperture 58, in which the actuating element 60 is received in a slidingly displaceable manner.

The actuating element 60 has a body 62 in the form of a push button 62, which has a collar 64 in its lower section that projects radially outwards and rests against the closure element 56 in the non-impressed state of the actuating element 60.

The elevation 52 merges radially outwardly into a recess 66. A coil spring 68 is arranged in such recess 66 on the one hand and between the section 69 of the body 62 projecting with respect to the collar 64 and the outer periphery of the cavity 54 on the other hand, and preloads the actuating element 60 in the upward direction, that is, against the actuating direction B of the actuating element 60. The coil spring 68 thereby provides the automatic return of the actuating element 60 from the actuated to the unactuated state.

This connection construction 10 now functions as follows:

In the state shown in FIG. 1, the centrifuge rotor 12 is placed with its hub 38 on the drive shaft 14 of the centrifuge motor. Thereby, the projections 24 of the spring elements 16 come into contact with the conical section 44 of the hub 38 by means of the chamfers 30, wherein the chamfers 30 and the conical section 44 thus provide a locking aid in that they prevent the projections 24 from tilting or catching on the hub 38.

At the same time, by steadily displacing the hub 38 further onto the drive shaft 14, the spring elements 16 are displaced inwardly to the extent that they can enter the inner cylinder 46, wherein, in extreme cases, the spring elements 16 can be swung in as far as the cylindrical section 22, such that the feet 26 can be displaced completely onto or behind the course of the conical profile of the conical section 34 and the step 36.

After the hub 38 has been pushed onto the drive shaft 14 to the extent that the projections 24 are no longer in contact with the inner cylinder 46, the spring elements 16 can relax, wherein the projections 24 are displaced outward on their own due to their preloading, until they are in contact with the edge 50. Thereby, the feet 26 rest against the step 48, such that the drive shaft 14 can no longer be pulled out of the hub 38. Due to the acting centrifugal forces, the spring elements 16 with the feet 26 are driven radially outwards relative to the shaft axis W during operation, such that such locking mechanism is self-locking during operation.

FIG. 6 shows that the projection 48 has a slope corresponding to the slope of the base 28 of the feet 26. This allows the feet 26 to shift early in the process of pushing the centrifuge rotor 12 onto the drive shaft 14, such that excessive vertical play between the feet 26 and the projection 48, and thus vertical “rattling” of hub 38 on drive shaft 14, is prevented.

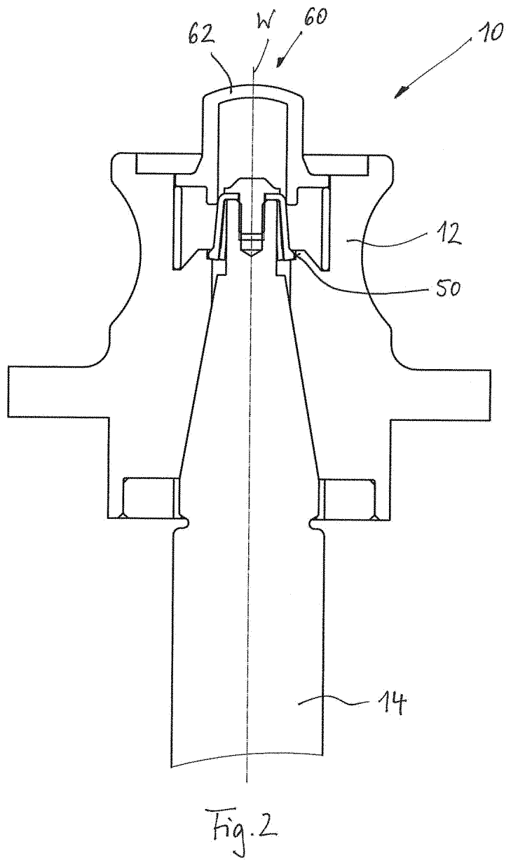

When the spring elements 16 are suddenly released, the projections 24 strike the edge 50, causing a clearly audible clicking, which clearly signals to the user that the locking between the hub 38 and the drive shaft 14 has occurred securely (see FIGS. 2 and 6).

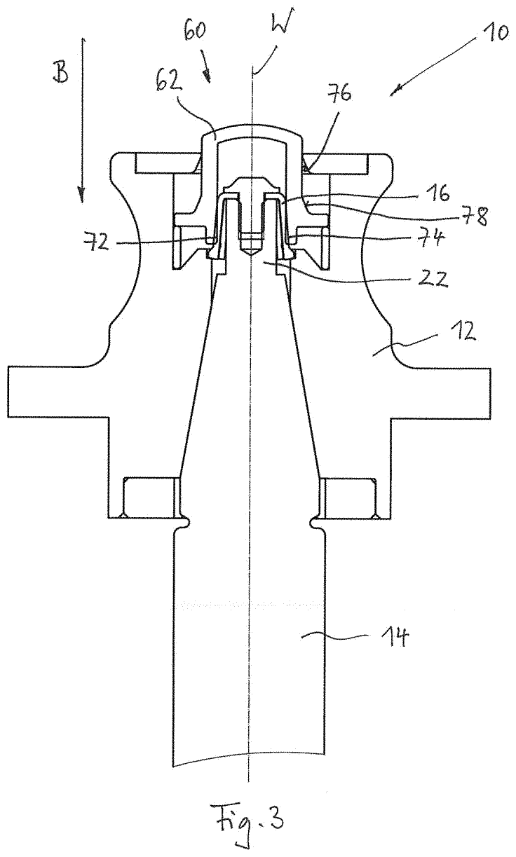

More specifically, each of the lever arms 16 is arranged at an acute angle with respect to the shaft axis (W) in the undeflected basic state shown in FIG. 1, wherein such angle is α=5°. In the locked state shown in FIG. 2, the angle is also α=5°, wherein such angle increases to 7° due to the centrifugal forces acting during operation, as a result of which the locking mechanism is self-locking during operation. In the unlocked state shown in FIG. 3, the angle is α=1°. This makes the locking mechanism particularly secure and easy to operate, and the click sound reliably indicates locking.

To release the locking mechanism, the push button 62 must be displaced in the actuating direction B, that is, downward. As a result, the contact surface 72 on the section 69 of the body 62 projecting with respect to the collar 64, which runs in the direction of the shaft axis W, is brought into contact with the mating contact surface 74, which is arranged on the spring element 16 and therefore runs at an angle with respect to the shaft axis W (see FIG. 3, the pivoting of the spring elements 16 inwards towards the cylindrical section 22 of the drive shaft 14 is not shown here for drawing-related reasons, but actually takes place).

As the push button 62 is depressed further in the actuating direction B, the mating contact surface 74 slides against the contact surface 72, by which a force is exerted on the spring elements 16, by which the feet 26 are displaced radially inward until they can be fully displaced onto or behind the course of the conical profile of the conical section 34. As a result, the feet 26 no longer rest against the step 48 and the hub 38 can be pulled off the drive shaft 14. The push button 62, after its release, slides upward driven by the coil spring 68 until the collar 64 rests against the closure element 56 (see FIG. 1).

It can also be seen that the aperture 58 includes a section 76 having a conical slope, which corresponds to a conical mating section 78 of the actuating element 60. As a result, the tilting of the actuating element 60 is effectively prevented when it is displaced by the coil spring 68 against the actuating direction B.

Although the first locking elements 16 have been described as lever arms 16 having projections 24 and feet 26 formed thereby, this comprises only one possible exemplary design. The spring elements 16 could also be formed without projections 24 and feet 26. This is advantageous if the spring elements 16 are made of spring steel, because, at that point, the design of the projections 24 and feet 26 is more complicated in terms of manufacturing than a design without such elements. Locking with the second locking element 48 would then be accomplished quite simply via straight extending ends (not shown) of the lever arms 16.

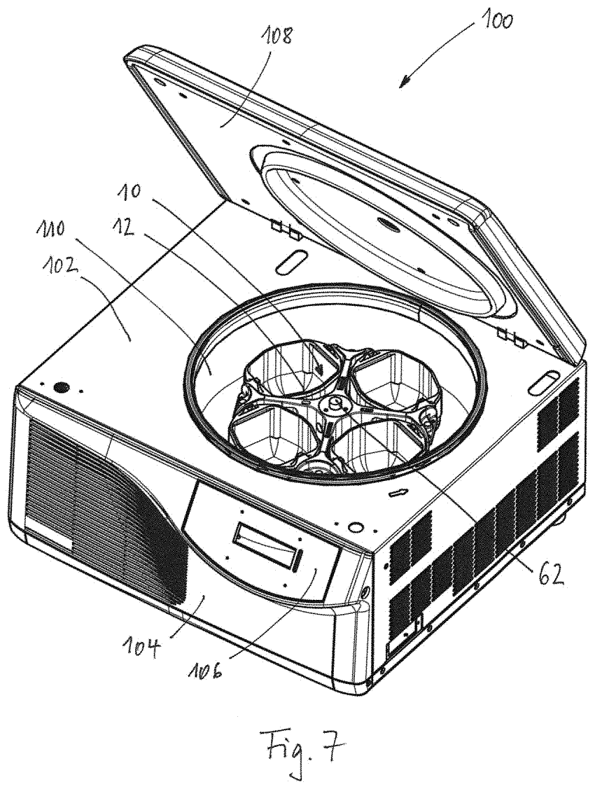

FIG. 7 shows a laboratory centrifuge 100 equipped with the connection construction 10.

It can be seen that such laboratory centrifuge 100 is formed in the usual manner, and thereby has a housing 102 with a control panel 106 arranged at its front side 104 and a lid 108, which is provided for closing the centrifuge container 110. A swing-out rotor 12 is arranged in the centrifuge container 110 as a centrifuge rotor, which can be driven by the drive shaft of a centrifuge motor (both not shown).

Although an example was shown above, with which spring elements 16 were used on the drive shaft 14, spring elements arranged in the hub can also be used.

Furthermore, the actuating element 60 also does not necessarily have to be arranged on the hub 38 of the centrifuge rotor 12; it can also be arranged on the drive shaft 14.

From the foregoing illustration, it has become clear that the present disclosure provides a connection construction 10 between the centrifuge rotor 12 and the drive shaft 14 of a laboratory centrifuge 100, which allows one-handed operation that does not require any additional tools. The connection construction 10 is constructed in such a manner that the locked state 16, 48 is always ensured, wherein the jamming or blocking of locking elements 16, 48 cannot take place. In addition, the user receives a reliable indication of a locked state 16, 48 by a clearly noticeable click.

Unless otherwise indicated, all features of the present disclosure can be freely combined. Also, unless otherwise indicated, the features described in the description of the figures can be freely combined with the other features. A limitation of individual features of the exemplary embodiments to the combination with other features of the exemplary embodiments is expressly not intended. In addition, the features of the subject matter can also be reformulated and used as method features, and the method features can be reformulated and used as features of the subject matter. Such a reformulation is thus automatically disclosed.

### LIST OF REFERENCE SIGNS

10 Connection construction according to a first preferred embodiment
12 Centrifuge rotor
14 Drive shaft
16 First locking elements, spring elements, lever arms
18 Spring crown
20 Screw
22 Cylindrical section of the drive shaft
24 Projections
26 Feet
28 Base, contact surface of the first connecting element 16
30 Chamfer
32 Joints
34 Conical section of the drive shaft 14
36 Radially running step
38 Hub of the centrifuge rotor 12
39 Receiving space for the drive shaft 14
40 Internal hexagon of the hub 38
42 External hexagon of the drive shaft 14
44 Inner cone of the hub 38
46 Inner cylinder of the hub 38
48 Annular step, second locking element, contact surface of the second connecting element 48
50 Vertical edge
52 Circumferential elevation
54 Cylindrical cavity of hub 38
56 Lid-shaped closure element
58 Aperture
60 Actuating element
62 Push button, body of the actuating element 60
64 Collar
66 Recess
68 Coil spring
69 Section of the body 62 protruding with respect to the collar 64
72 Contact surface
74 Mating contact surface
76 Section with conical slope of the aperture 58
78 Conical counter section of the actuating element 60
100 Laboratory centrifuge
102 Housing
104 Front side of the housing 102
106 Control panel
108 Lid
110 Centrifuge container
a Angle between lever 16 and shaft axis W
B Actuating direction of the actuating element 60
W Shaft axis

1.-15. (canceled)

16. A connection construction (10) between a centrifuge rotor (12) and a drive shaft (14) of a centrifuge motor, the drive shaft (14) extending along a shaft axis (W), wherein
a first locking element (16) is arranged on one of the elements of the centrifuge rotor (12) and the drive shaft (14), and
a second locking element (48) is arranged on another of the elements of the centrifuge rotor (12) and the drive shaft (14),
wherein the first locking element (16) is engaged with the second locking element (48) in a locked state of the connection and is disengaged in an unlocked state,
wherein there is an actuating means (60) on one of the elements of centrifuge rotor (12) and drive shaft, an actuation of which causes the first locking element (16) to disengage from the second locking element (48), whereby the centrifuge rotor (12) is removable from the drive shaft (14).

17. The connection construction (10) according to claim 16,
wherein the first locking element (16) is a lever having a lever arm which is movable in a plane parallel to the shaft axis (W).

18. The connection construction (10) according to claim 17,
wherein the lever arm is movable in a plane that includes the shaft axis (W).

19. The connection construction (10) according to claim 17,
wherein the lever (16), in an undeflected basic state, is arranged at an acute angle with respect to the shaft axis (W), and/or
wherein the connection construction (10) is adapted such that the lever (16) is deflectable, due to centrifugal forces, in a first operating state in which the centrifuge rotor (12) is rotating relative to a second operating state in which the centrifuge rotor (12) not rotating, wherein the deflection relative to the second operating state is in the range of 1° to 5°.

20. The connection construction (10) according to claim 17,
wherein the lever (16) is arranged at a joint (32),
wherein the joint (32) is formed to be spring-loaded, and
wherein the joint (32) is effected by an elastic, spring-loaded design of the lever (16) itself.

21. The connection construction (10) according to claim 16,
wherein the first locking element (16) has a foot (26) that stands (28) on the second locking element (48).

22. The connection construction (10) according to claim 17,
wherein the first locking element (16) has at least one chamfer (30), which serves as a locking aid,
wherein the chamfer (30) lies parallel to a longitudinal extension of the lever (16).

23. The connection construction (10) according to claim 16,
wherein the first locking element (16) is preloaded in a direction of engagement with the second locking element (48).

24. The connection construction (10) according to claim 16,
wherein there are at least four first locking elements (16).

25. The connection construction (10) according to claim 16,
wherein the first locking element (16) is arranged on the drive shaft (14).

26. The connection construction (10) according to claim 16,
wherein the second locking element (48) is a projection on the centrifuge rotor (12), against which the first locking element (16) is supported in the locked state.

27. The connection construction (10) according to claim 16,
wherein the actuating means (60) has a contact surface (72) for a mating contact surface (74) of the first locking element (16),
wherein one of the two surfaces of contact surface and mating contact surface (74) has an inclined course in the actuating direction (B) of the actuating means (60), at least in the locked state of the connection construction (10), in such a manner such that actuation of the actuating means (60) causes the first locking element (16) to pivot,
wherein the mating contact surface (74) runs in a manner inclined to the direction of the shaft axis (W) in the locked state.

28. The connection construction (10) according to claim 16,
wherein the first locking element (16) and the second locking element (48) have contact surfaces (28, 48) that, in the locked state of the connection construction (10), bear against one another and effect the locking,
wherein such contact surfaces (28, 48) are inclined with respect to a radial surface about the shaft axis (W).

29. The connection construction (10) according to claim 16,
wherein the actuating means (60) is formed as a push button (62) that is preloaded (68) against the actuating direction (B).

30. The connection construction (10) according to claim 16,
wherein the actuating means (60) is arranged on the centrifuge rotor (12).

31. The connection construction (10) according to claim 16,
wherein the connection construction (10) provides a snap-in connection (16, 48),
wherein the locking takes place within a clip connection (16, 48), which is designed to be releasable.

32. A connection (10) between a centrifuge rotor (12) and a drive shaft (14), comprising:
a lever (16) arranged on the drive shaft (14), the lever having a lever arm which is movable in a plane that includes a shaft axis (W) of the drive shaft (14);
a projection (48) formed on the centrifuge rotor (12), against which the lever (16) is supported in a locked state of the connection;
a push button (62) arranged on the centrifuge rotor (12) that is preloaded (68) against an actuating direction (B),
wherein the push button (62) has a contact surface (72) for a mating contact surface (74) of the lever, and
wherein an actuation of the push button (62) causes the lever (16) to disengage from the projection on the centrifuge rotor (12), so that the centrifuge rotor (12) can be removed from the drive shaft (14).
